(19) United States
(12) Patent Application Publication
(10) Pub. No.: US 2017/0257599 A1
(43) Pub. Date: Sep. 7, 2017

(54) Self-Adaptive Display Method and Device for Image of Mobile Terminal, and Computer Storage Medium

(71) Applicant: ZTE CORPORATION, Shenzhen City (CN)

(72) Inventors: Xiaoyan LUO, Shenzhen City (CN); Bin FENG, Shenzhen City (CN); Cunwang ZHU, Shenzhen City (CN); Mu LIU, Shenzhen City (CN)

(73) Assignee: ZTE CORPORATION, Shenzhen City (CN)

(21) Appl. No.: 15/323,229

(22) PCT Filed: Oct. 24, 2014
(86) PCT No.: PCT/CN2014/089438

§ 371 Date: Apr. 19, 2017

(30) Foreign Application Priority Data
Jun. 30, 2014 (CN) 201410309612.9

(51) Int. Cl. H04N 7/15; H04N 7/01; H04N 5/445

(52) U.S. Cl. CPC H04N 7/152; H04N 5/44591; H04N 7/0117

(57) ABSTRACT

A self-adaptive display method for an image of a mobile terminal is described. The method includes: determining, by a multipoint control terminal, the number K of sub-pictures which are permitted to be displayed by a mobile terminal in a current placement state; and selecting and sending K sub-pictures to the mobile terminal for display. A self-adaptive display device for an image of a mobile terminal, and a computer storage medium are also described.

### CROSS-REFERENCE TO RELATED APPLICATION

This application is the U.S. national phase of PCT Application No. PCT/CN2014/089438 filed Oct. 24, 2014, which claims priority to Chinese Application No. 201410309612.9 filed Jun. 30, 2014, the disclosures of which are incorporated in their entirety by reference herein.

### TECHNICAL FIELD

The present disclosure relates to a video conference technology, in particular to an adaptive display method, a device and a computer storage medium for realizing the image of a mobile terminal.

### BACKGROUND

With the development of the communication technology and the mobile terminal technology, the mobile terminal can also be added to the video conference to perform the video and voice communication in real time. However, when the mobile terminal performs the multipoint video conference, due to the flexibility of the mobile terminals, for example, the mobile terminal can be freely rotated, the multi-pictures displayed on the mobile terminal should also generate the corresponding rotation when the mobile terminal is rotated, in order to meet the experience and the demand of the mobile terminal user. However, in the current technology, such as, displayed video picture rotating method proposed in the Chinese patent document with the public number as CN103220485A and the title of invention as “Displayed video picture rotating method and system”, the picture rotation request sent by the terminal needs the user to participate, which is not self-adaptive; while in the Chinese patent document with the public number as CN101673537 and the title of invention as “Device and method for implementing selection of screen image”, although the gravity sensing device is used to solve the automatic image rotation problem, however, the common problem of the above two lies in that the entire image of the picture is regarded as the processing unit during the picture rotation to rotate and zoom the picture, while it is unable to adjust the layout of each subpicture in the multi-pictures. Due to the limitation of the volume of the mobile terminal, the size and area of its display screen are limited; and especially when the multipoint video communication is performed and the participants are more, the small display screen cannot display clearly the contents of various pictures when more pictures are displayed.

### SUMMARY

In order to solve the existing technical problems, the embodiment of the present disclosure is expected to provide a self-adaptive display method and device for an image of a mobile terminal and a computer storage medium.

The technical scheme of the embodiment of the present disclosure is realized like this:

the embodiment of the present disclosure provides a self-adaptive display method for an image of a mobile terminal, including:

determining, by a multipoint control terminal, the number K of sub-pictures which are permitted to be displayed by a mobile terminal in a current placement state; and selecting and sending K sub-pictures to the mobile terminal for display.

The embodiment of the present disclosure further provides a self-adaptive display device for an image of a mobile terminal, including: a sub-picture determination module and a sub-picture selection module; herein,

the sub-picture determination module determines the number K of sub-pictures which are permitted by the mobile terminal in the current placement state; and

the sub-picture selection module selects and sends K sub-pictures to the mobile terminal for display.

The embodiment of the present disclosure further provides a computer storage medium, storing a computer program therein, and the computer program performs the above self-adaptive display method for an image of a mobile terminal.

The embodiment of the present disclosure provides a self-adaptive display method and device for an image of a mobile terminal and a computer storage medium, a multipoint control terminal determines the number K of sub-pictures which are permitted to be displayed by a mobile terminal in a current placement state; and selects and sends K sub-pictures to the mobile terminal for display. So, the layout and content of the multi-pictures displayed by the mobile terminal are adjusted in real time dynamically according to the change of the placement state of the mobile terminal (such as, horizontal or vertical placement), so as to enhance the comfortable sensation to the picture of the customer performing the video communication by using mobile terminal.

### BRIEF DESCRIPTION OF DRAWINGS

FIG. 1 is a flow chart of a self-adaptive display method for an image of a mobile terminal provided by an embodiment of the present disclosure;

FIG. 2 is a flow chart of a self-adaptive display method for an image of a mobile terminal provided by embodiment one of the present disclosure;

FIG. 3 is a schematic diagram of adjusting layout of multi-pictures provided by embodiment two of the present disclosure;

FIG. 4 is a schematic diagram of adjusting layout of multi-pictures provided by embodiment three of the present disclosure;

FIG. 5 is a flow chart of a processing method when A receives screen rotation information of D provided by embodiment three of the present disclosure;

FIG. 6 is a structural schematic diagram of a self-adaptive display device for an image of a mobile terminal provided by an embodiment of the present disclosure.

### DETAILED DESCRIPTION

In the embodiment of the present disclosure, a multipoint control terminal determines the number K of sub-pictures which are permitted to be displayed by a mobile terminal in a current placement state, and selects and sends K sub-pictures to the mobile terminal for display.

The present disclosure is further illustrated in details through the accompanying drawings and specific embodiments.

The embodiment of the present disclosure realizes a self-adaptive display method for an image of a mobile terminal. As shown in FIG. 1, the method includes the following steps 101-102.

In step 101: the multipoint control terminal determines the number K of the sub-pictures which are permitted to be displayed in the current placement state of the mobile terminal.

Specifically, in a multi-point video conference, the multipoint control terminal determines the number K of the sub-pictures which are permitted to be displayed by the mobile terminal in the placement state according to the current placement state of the mobile terminal in a multi-point video conference, screen information of the mobile terminal, and resolutions of video images of N conference terminal, herein, N represents the number of all conference terminals; or, the multipoint control terminal receives the number K of the sub-pictures which are permitted to be displayed in the current placement state sent by the mobile terminal in the multi-point video conference; the number K of the sub-pictures which are permitted to be displayed in the current placement state sent by the mobile terminal is: the mobile terminal determining the number K of the sub-pictures which are permitted to be displayed in the placement state according to the current placement state of the mobile terminal, screen information of the mobile terminal and resolution of video image of the mobile terminal. Here, the all conference terminals include: a multipoint control terminal, a mobile terminal and an ordinary video terminal, the multipoint control terminal refers to a terminal which is provided with a multipoint control unit (Multi Control Unit, MCU).

In addition, in the multi-point video conference, the multipoint control terminal can also identify a mobile terminal in the conference terminal, and determine the mobile terminal in the conference terminal according to the identification in the interactive information.

In the present step, the placement state includes: horizontal placement and vertical placement, and the screen information includes: physical dimension and aspect ratio of the screen.

The placement state and the screen information can be obtained by the multipoint control terminal through the interaction information during the interaction with of the mobile terminal, and the mobile terminal can obtain its own placement state through a built-in gravity induction device, and can obtain the screen information from its own stored device parameters, and carries the placement state and the screen information in the interactive information during the interaction with the multipoint control terminal; and the resolutions of the video images of the N conference terminals can be obtained by the multipoint control terminal when decoding the video images of the N conference terminals.

Here, the multipoint control terminal determining the number K of the sub-pictures which are permitted to be displayed by the mobile terminal in the placement state according to the current placement state of the mobile terminal in the multi-point video conference, the screen information of the mobile terminal, and the resolutions of video images sent by N conference terminals, includes: assuming that the received physical dimension of the screen of the mobile terminal is S (of which the unit is in), the aspect ratio of the screen is Wr:Hr, and the placement state is C, and setting the reference image resolution Rw*Rh and parameter t.

Firstly, width (W) and height (H) of the screen of the mobile terminal are calculated,

W/H=Wr/Hr

W²+H²=(S*2.54)².

The solution of the above equations is the calculated width and height of the screen (of which the unit is cm).

Then, the number K of the sub-pictures which can be displayed by the mobile terminal is calculated.

When the placement state of the screen C is the horizontal placement, N1=floor (W/(Rw*t)), and N2=floor (H/(Rh*t)).

When the placement state of the screen C is the vertical placement, N1=floor (H/(Rw*t)), and N2=floor (W/(Rh*t)).

Herein, floor is a function which returns a maximum integer that is less than or equal to a specified expression; and a minimum value of N1 and N2 is 1.

K=N1*N2.

The setting of the above reference image resolution Rw*Rh can be dynamically set according to the resolutions of the video images sent by N−1 conference terminals and the resolution of the video image the multi-point control terminal and also can be set to a fixed value.

In step 102: the multipoint control terminal selects and sends K sub-pictures to the mobile terminal for display.

Specifically, the multipoint control terminal selects and sends the K sub-pictures to the mobile terminal for display according to the selection criteria, the selection criteria includes: any criterion of volume size, resolution of a video image, bandwidth, chairman end, broadcast source and importance degree, etc.; or, a criterion obtained by combining at least two criteria of volume size, resolution of the video image, bandwidth, chairman end, broadcast source and importance degree, etc., in a weighting scheme; or, the multipoint control terminal selecting the sub-pictures by a mode of interacting with other conference terminals.

For example, the multipoint control terminal can select and send the K sub-pictures to the mobile terminal for display according to the volume sizes of the video images of the N conference terminals, for example, ranking the video images of the N conference terminals according to the volume sizes, and selecting K video images with big volume or small volume as the sub-pictures and sending to the mobile terminal for display.

Or, the multipoint control terminal can select the K sub-pictures for display according to the resolutions of the video images of the N conference terminals, for example, ranking the video images sent by the N conference terminals according to the resolution sizes, and selecting K video images with big resolution or small resolution as the sub-pictures and sending to the mobile terminal for display.

Or, the multipoint control terminal can select the K sub-pictures for display according to the bandwidths of the video images of the N conference terminals, for example, ranking the video images of the N conference terminals according to the bandwidth sizes, and selecting K video images with big bandwidth or small bandwidth as the sub-pictures and sending to the mobile terminal for display.

Or, the multipoint control terminal can select the K sub-pictures for display according to the chairman end in the N conference terminals, for example, identifying video images sent by the chairman ends in the video images of the N conference terminals, selecting K video images including the video images sent by the chairman end as the sub-pictures and sending to the mobile terminal for display.

Or, the multipoint control terminal can select the K sub-pictures for display according to the broadcast sources in the N conference terminals, for example, identifying the broadcast sources in the N conference terminals, selecting K video images including the video images sent by the broadcast source as the sub-pictures and sending to the mobile terminal for display.

Or, the multipoint control terminal can select the K sub-pictures for display according to the importance degrees of the video images of the N conference terminals, for example, identifying the importance degrees of the video images of the N conference terminals, selecting K video images of which the importance degrees are high as the sub-pictures and sending to the mobile terminal for display.

Or, the multipoint control terminal can select the K sub-pictures for display according to the volume sizes and resolutions of the video images of the N conference terminals, for example, sorting the video images of the N conference terminals according to the volume sizes, recording the ranking of the various conference terminals, then sorting the video images of the N conference terminals according to the resolutions, recording the ranking of the various conference terminals, and finally weighting the ranking of the N conference terminals according to the sorting of the volume sizes and the ranking according to the sorting of the resolutions, and selecting K video images with a high weighted value or a low weighted value as the sub-pictures and sending to the mobile terminal for display.

Or, the multipoint control terminal can select the K sub-pictures for display according to the bandwidths of the video images sent by the N conference terminals and the chairman end in the N conference terminals, for example, sorting the video images of the N conference terminals according to the bandwidth sizes, selecting the video images sent by the chairman end as a sub-picture for display, and selecting K−1 video images with the big bandwidth or small bandwidth as the sub-picture and sending to the mobile terminal for display.

Similarly, the multipoint control terminal can combine at least two criteria of volume size, resolution of a video image, bandwidth, chairman end, broadcast source and importance degree, etc., in a weighting scheme, and select K video images in the video images of N conference terminals as the sub-picture and send to the mobile terminal for display.

In addition, the multipoint control terminal can send a request message whether the display is required to other conference terminals, and select K video images in the video images sent by the conference terminal which requires the display as the sub-picture and send to the mobile terminal for display.

In the present step, the selecting and sending K sub-pictures to the mobile terminal includes: adjusting a display layout of the K sub-pictures, and sending video images of the K sub-pictures and the adjusted display layout to the mobile terminal; which specifically can be: pre-storing a layout template aimed at various numbers of sub-pictures, determining the used layout template according to the selected K sub-pictures, adjusting display size of the K video images according to the size of various sub-pictures in the used layout template, and sending the K video images and the used layout template to the mobile terminal; the layout template includes: a vertical layout template, a horizontal layout template, a grid layout template, an irregular sub-picture layout template, etc.

The adjusting the display layout of the K sub-pictures further includes: adjusting the display layout of parts of the sub-pictures in the K sub-pictures, which specifically can be: in the K sub-pictures, the display positions of L sub-pictures in a previous placement state relative to the current placement state are maintained as unchanged, M sub-pictures are adjusted to an empty display area suitable for the current placement state of the mobile terminal; if the current placement state is the horizontal placement, then the M sub-pictures are adjusted to the horizontal empty display area, and the sum of the M sub-pictures and the L sub-pictures is the K sub-pictures.

When the placement state of the mobile terminal is changed, the above method further includes: re-determining, by the multipoint control terminal, the number R of sub-pictures which are permitted to be displayed by the mobile terminal in a current placement state; and selecting and sending R sub-pictures to the mobile terminal for display.

In order to better understand the present disclosure, the present disclosure is further described by combining with the specific embodiments hereinafter.

### Embodiment One

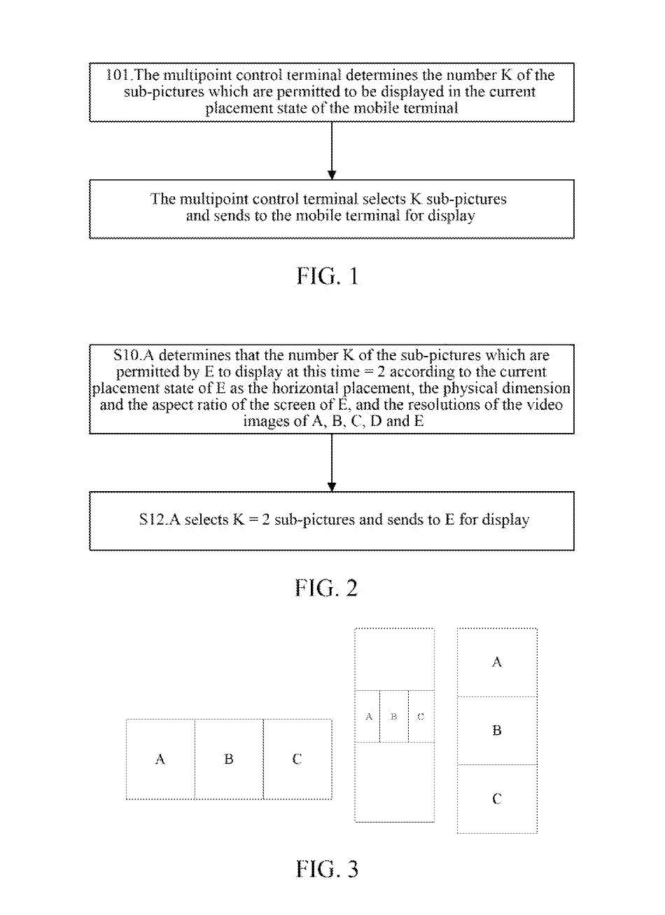

Hereinafter by taking 5 conference terminals (A, B, C, D and E) performing the video conference as an example, herein, A is the multipoint control terminal, E is the mobile terminal, and B, C and D are common video terminals; while the self-adaptive display method for the image of the mobile terminal realized by the present embodiment, as shown in FIG. 2, includes steps S10-S11.

In step S10, A determines that the number K of the sub-pictures which are permitted by E to display at this time=2 according to the current placement state of E is the horizontal placement, the physical dimension and the aspect ratio of the screen of E, and the resolutions of the video images of A, B, C, D and E.

In step S11, A selects K=2 sub-pictures and sends them to E for display.

Here, due to K<N (N=5), then it is required to select the sub-pictures according to the selection criteria. Assuming that the set selection criterion for the sub-pictures is to select the sub-pictures according to the resolutions of the video images, and a relationship of the video resolutions of the five mobile terminals is: RA_B>RA_D>RA_A>RA_C>RA_E, and then two sub-pictures with the large resolutions, that is, the pictures of B and D, are selected according to the selection criteria, as the display sub-picture of E.

### Embodiment Two

Hereinafter by taking 3 conference terminals (A, B and C) performing the video conference as an example, herein, A is the multipoint control terminal, C is the mobile terminal, and B is a common video terminal; while the self-adaptive display method for the image of the mobile terminal realized by the present embodiment includes: A determines that the number K of the sub-pictures which can be displayed by C at this time=3 according to the current placement state of C is the horizontal placement, the physical dimension and the aspect ratio of the screen of C, and the resolutions of the video images of A, B and C, that is, all conference terminals of the terminals attending the conference can be displayed at this time.

The K sub-pictures to be displayed are selected according to the selection criteria, at this time, K=N=3, then the three pictures of A, B and C are selected as the display sub-picture of C, and the selected K sub-pictures are sent to C for display.

Assuming that the multi-picture layout of C is shown as the left chart in FIG. 3 at this time, the layouts of the three terminals, A, B and C, are arranged from left to right; FIG. 3 is only used for the description of the layout adjustment strategy of the multi-pictures, while not limited to the situation of using other layout adjustment strategies. If C is rotated from the initial horizontal placement to the vertical placement in the process of the video conference, then A will receive the change information of the placement state of C, thus it recalculates the number R of the sub-pictures which can be displayed by C in the vertical state; assuming that R=3 is calculated and obtained at this time, then the three pictures of A, B and C are selected as the display sub-picture of C; and now it is required to adjust the layout of the sub-pictures, the position of the sub-pictures of B can be maintained as unchanged, and the sub-pictures of A and C are adjusted to empty display area at the vertical direction, and the adjusted multi-picture layout is shown as the right chart in FIG. 3. In the embodiment, it is assumed that each sub-picture occupies ⅓ of the entire screen. The middle schematic chart in FIG. 3 is a multi-picture display effect obtained by the related art, and the proportion of the screen area occupied by the final image picture of the technology is small, which does not fully utilize the entire display screen.

### Embodiment Three

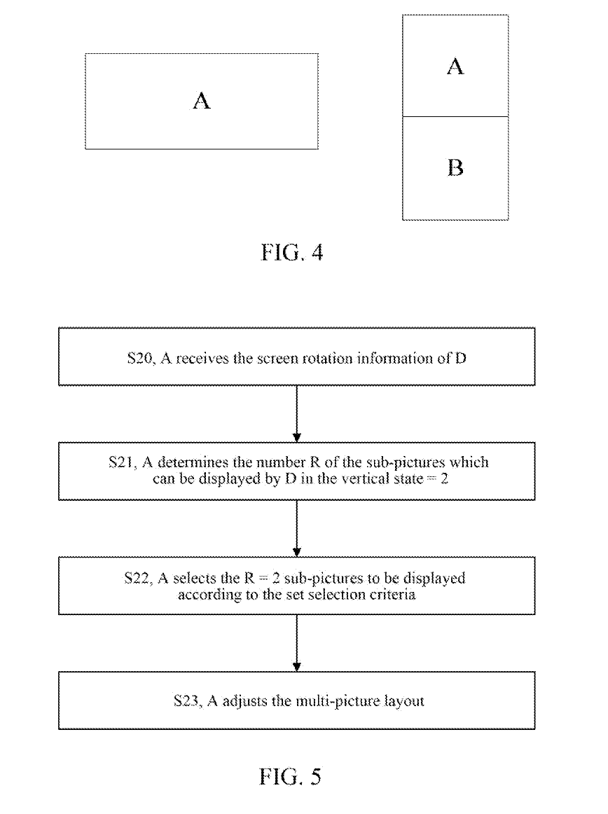

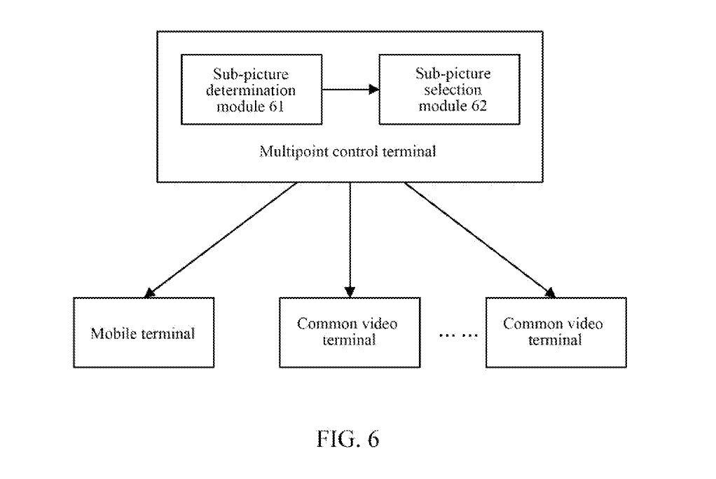

Hereinafter by taking 4 conference terminals (A, B, C and D) performing the video conference as an example, herein, A is the multipoint control terminal, D is the mobile terminal, and B and C are common video terminals; assuming that the screen size of D is 3.5 in, the aspect ratio of the screen is 3:2, and the placement position before the rotation is the horizontal placement; assuming that it is calculated that the number of the sub-pictures which can be displayed by D is 1 at this time and pictures of A are selected according to the selection criteria for display, the display schematic diagram is shown in the left chart of FIG. 4; D is rotated in the process of attending the conference, the placement state is changed from the horizontal position into the vertical placement, and the process when A receives the screen rotation information of D is as shown in FIG. 5, including steps S20-S23.

In step S20, A receives the screen rotation information of D.

In step S21, A determines the number R of the sub-pictures which can be displayed by D in the vertical state=2, and the calculation of R needs to be calculated according to the information, such as, the screen size and aspect ratio of D, and the resolutions of the video images of the four conference terminals, A, B, C and D, etc.

In step S22, A selects the R=2 sub-pictures to be displayed according to the set selection criteria.

Here, it is assumed that the selection criteria are: selecting according to the volume size of the parties attending the conference from large to small; while if at this time the relationship of the volume sizes of various terminals is: VA>VB>VC>VD, then finally the pictures of terminal A and terminal B are selected as the display sub-picture of D according to the selection criteria.

In step S23, A adjusts the multi-picture layout.

Here, as shown in the right chart of FIG. 4, A can adjust the display layout as vertically arranging the picture of A and the picture of B, to regenerate the sub-picture layout of D, and A sends the picture of A, the picture of B and the regenerated sub-picture layout to D for display.

### Embodiment Four

Hereinafter by taking 5 conference terminals (A, B, C, D and E) performing the video conference as an example, herein, A is the multipoint control terminal, E is the mobile terminal, and B, C and D are common video terminals; while the self-adaptive display method for the image of the mobile terminal realized by the present embodiment includes: E determines that the number K of the sub-pictures which are permitted by E to display at this time=2 according to its own current placement state is the horizontal placement, the physical dimension and the aspect ratio of its own screen, and the resolution of its own video image, and carries the number of the sub-pictures which are permitted to display K=2 in the interactive information with A, and the interactive information can be a conference video connection confirmation or a conference video connection request etc.

A receives the number of the sub-pictures which are permitted by E to display K=2, and selects K=2 sub-pictures and sends them to E for display.

Here, due to K<N (N=5), then it is required to select the sub-pictures according to the selection criteria. Assuming that the set selection criterion for the sub-pictures is to select the sub-pictures according to the resolutions of the video images, then a relationship of the video resolutions of the five mobile terminals is: RA_B>RA_D>RA_A>RA_C>RA_E, and then two sub-pictures with the large resolutions, that is, the pictures of B and D, are selected according to the selection criteria, as the display sub-picture of E.

Based on the above self-adaptive display method for an image of a mobile terminal, the embodiment of the present disclosure further provides a self-adaptive display device for the image of the mobile terminal, herein, the device is arranged in the multipoint control terminal, as shown in FIG. 6, the device includes: a sub-picture determination module 61 and a sub-picture selection module 62.

The sub-picture determination module 61 can be realized by combining a communication interface and a processor, and determines the number K of sub-pictures which are permitted to be displayed by a mobile terminal in a current placement state.

In the multi-point video conference, the sub-picture determination module 61 determines the number K of the sub-pictures which are permitted to be displayed by the mobile terminal in the placement state according to the current placement state of the mobile terminal in a multi-point video conference, screen information of the mobile terminal, and resolutions of video images of N conference terminal, N represents the number of all conference terminals; here, the all conference terminals include: a multipoint control terminal, a mobile terminal, and a common video terminal.

For obtaining the placement state and the screen information, the sub-picture determination module 61 can obtain through the interaction information during the interaction between the multipoint control terminal where itself is located and the mobile terminal, and the mobile terminal can obtain its own placement state through a built-in gravity induction device, and can obtain the screen information from its own stored device parameters, and carries the placement state and the screen information in the interactive information during the interaction with the multipoint control terminal; for obtaining the resolutions of the video images of the N conference terminals, the sub-picture determination module 61 can obtain when decoding the video images of the N conference terminals.

The sub-picture determination module 61 also can receive the number K of the sub-pictures which are permitted to be displayed in the current placement state sent by the mobile terminal in the multi-point video conference; the number K of the sub-pictures which are permitted to be displayed in the current placement state sent by the mobile terminal is: the mobile terminal determining the number K of the sub-pictures which are permitted to be displayed in the placement state according to the current placement state of the mobile terminal, screen information of the mobile terminal and resolution of video image of the mobile terminal.

The sub-picture selection module 62 can be realized by combining with the communication interface and the processor, and selects and sends K sub-pictures to the mobile terminal for display.

Specifically, the sub-picture selection module 62 selects and sends the K sub-pictures to the mobile terminal for display according to the selection criteria, the selection criteria includes: any criterion of volume size, resolution of a video image, bandwidth, chairman end, broadcast source and importance degree, etc.; or, a criterion obtained by combining at least two criteria of volume size, resolution of the video image, bandwidth, chairman end, broadcast source and importance degree, etc., in a weighting scheme; or, the multipoint control terminal selecting the sub-pictures by a mode of interacting with N−1 conference terminals.

The sub-picture determination module 61 is further arranged to: re-determine the number R of sub-pictures which are permitted to be displayed by the mobile terminal in the current placement state when the placement state of the mobile terminal is changed; and the sub-picture selection module 62 is further arranged to select and send R sub-pictures to the mobile terminal for display.

When the self-adaptive display method for the image of the mobile terminal described by the embodiment of the present disclosure is realized in the form of software functional module and is sold or used as an independent product, it may be stored in a computer readable storage medium. Based on that understanding, those skilled in the art shall understand that the embodiment of the present application can be provided as a method, system, or computer program product. Therefore, the present application can use the form of entire hardware embodiment, entire software embodiment, or embodiment combining with software and hardware. Moreover, the application can adopt the form of computer program products implemented in one or more computer storage mediums which contain a computer usable program code, and the computer storage medium includes but not limited to U disk, mobile hard disk, read-only memory (ROM), disk storage, CD-ROM, optical memory, etc.

Accordingly, the embodiment of the present disclosure further provides a computer storage medium, storing a computer program therein, and the computer program performs the self-adaptive display method for the image of the mobile terminal of the embodiment of the present disclosure.

The above description is only the preferred embodiments of the present disclosure and is not used to limit the protective scope of the present disclosure. Any modification, equivalent substitution and improvement within the spirit and principle of the present disclosure should be included in the protective scope of the present disclosure.

### INDUSTRIAL APPLICABILITY

Combining with the technical schemes described in various embodiments, the present disclosure can adjust the layout and content of the multi-pictures displayed by the mobile terminal in real time dynamically according to the change of the placement state of the mobile terminal (such as, horizontal placement or vertical placement), so as to enhance the comfortable sensation to the picture of the customer performing the video communication by using mobile terminal.

1. A self-adaptive display method for an image of a mobile terminal, comprising:
determining, by a multipoint control terminal, the number K of sub-pictures which are permitted to be displayed by a mobile terminal in a current placement state; and selecting and sending K sub-pictures to the mobile terminal for display.

2. The self-adaptive display method according to claim 1, wherein, the determining, by the multipoint control terminal, the number K of sub-pictures which are permitted to be displayed by the mobile terminal in the current placement state comprises: the multipoint control terminal determining the number K of the sub-pictures which are permitted to be displayed by the mobile terminal in the placement state according to the current placement state of the mobile terminal in a multi-point video conference, screen information of the mobile terminal, and resolutions of video images of N conference terminals, wherein, N represents the number of all conference terminals.

3. The self-adaptive display method according to claim 1, wherein, the determining, by the multipoint control terminal, the number K of sub-pictures which are permitted to be displayed by the mobile terminal in the current placement state comprises: the multipoint control terminal receiving the number K of the sub-pictures which are permitted to be displayed in the current placement state sent by the mobile terminal in a multi-point video conference; the number K of the sub-pictures which are permitted to be displayed in the current placement state sent by the mobile terminal is: the mobile terminal determining the number K of the sub-pictures which are permitted to be displayed in the placement state according to the current placement state of the mobile terminal, screen information of the mobile terminal and resolution of video image of the mobile terminal.

4. The self-adaptive display method according to claim 1, wherein, the selecting and sending K sub-pictures to the mobile terminal for display comprises: selecting and sending K sub-pictures to the mobile terminal for display according to a selection criterion.

5. The self-adaptive display method according to claim 4, wherein, the selection criteria comprises: any criterion of volume size, resolution of a video image, bandwidth, chairman end, broadcast source and importance degree; or, a criterion obtained by combining at least two criteria, in a weighting scheme, of volume size, resolution of the video image, bandwidth, chairman end, broadcast source and importance degree; or, the multipoint control terminal selecting the sub-pictures by a mode of interacting with other conference terminals.

6. The self-adaptive display method according to claim 5, wherein, the selecting and sending K sub-pictures to the mobile terminal comprises: adjusting a display layout of the K sub-pictures, and sending video images of the K sub-pictures and the adjusted display layout to the mobile terminal.

7. The self-adaptive display method according to claim 6, wherein, the adjusting a display layout of the K sub-pictures comprises: adjusting a display layout of parts of sub-pictures in the K sub-pictures.

8. The self-adaptive display method according to claim 1, wherein, when the placement state of the mobile terminal is changed, the method further comprises: re-determining, by the multipoint control terminal, the number R of sub-pictures which are permitted to be displayed by the mobile terminal in the current placement state; and selecting and sending R sub-pictures to the mobile terminal for display.

9. A self-adaptive display device for an image of a mobile terminal, comprising: a sub-picture determination module and a sub-picture selection module; wherein,
the sub-picture determination module determines the number K of sub-pictures which are permitted by the mobile terminal in a current placement state; and
the sub-picture selection module selects and sends K sub-pictures to the mobile terminal for display.

10. The self-adaptive display device according to claim 9, wherein, the sub-picture determination module determines the number K of the sub-pictures which are permitted to be displayed by the mobile terminal in the placement state according to the current placement state of the mobile terminal in a multi-point video conference, screen information of the mobile terminal, and resolutions of video images of N conference terminals, wherein, N represents the number of all conference terminals.

11. The self-adaptive display device according to claim 9, wherein, the sub-picture determination module receives the number K of the sub-pictures which are permitted to be displayed in the current placement state sent by the mobile terminal in a multi-point video conference; and the number K of the sub-pictures which are permitted to be displayed in the current placement state sent by the mobile terminal is: the mobile terminal determining the number K of the sub-pictures which are permitted to be displayed in the placement state according to the current placement state of the mobile terminal, screen information of the mobile terminal and resolution of video image of the mobile terminal.

12. The self-adaptive display device according to claim 9, wherein, the sub-picture selection module selects and sends K sub-pictures to the mobile terminal for display according to a selection criterion.

13. The self-adaptive display device according to claim 9, wherein,
the sub-picture determination module is further arranged to: re-determine the number R of sub-pictures which are permitted to be displayed by the mobile terminal in the current placement state when the placement state of the mobile terminal is changed; and
the sub-picture selection module is further arranged to select and send R sub-pictures to the mobile terminal for display.

14. A computer storage medium, storing a computer program therein, and the computer program performs the self-adaptive display method for an image of a mobile terminal in claim 1.

15. A computer storage medium, storing a computer program therein, and the computer program performs the self-adaptive display method for an image of a mobile terminal in claim 2.

16. A computer storage medium, storing a computer program therein, and the computer program performs the self-adaptive display method for an image of a mobile terminal in claim 3.

17. A computer storage medium, storing a computer program therein, and the computer program performs the self-adaptive display method for an image of a mobile terminal in claim 4.

18. A computer storage medium, storing a computer program therein, and the computer program performs the self-adaptive display method for an image of a mobile terminal in claim 5.

19. A computer storage medium, storing a computer program therein, and the computer program performs the self-adaptive display method for an image of a mobile terminal in claim 6.

20. A computer storage medium, storing a computer program therein, and the computer program performs the self-adaptive display method for an image of a mobile terminal in claim 7.
